(19) United States
(12) Patent Application Publication
(10) Pub. No.: US 2012/0083151 A1
(43) Pub. Date: Apr. 5, 2012

(54) METHOD OF DETACHMENT OF CONNECTOR, CONNECTOR DETACHMENT TOOL, AND CONNECTOR

(75) Inventors: Rie TAKADA, Kawasaki (JP); Tsuyoshi YAMAMOTO, Kawasaki (JP); Naoaki NAKAMURA, Kawasaki (JP); Harumi YAGI, Kawasaki (JP)

(73) Assignee: FUJITSU LIMITED, Kawasaki-shi (JP)

(21) Appl. No.: 13/185,970

(22) Filed: Jul. 19, 2011

(30) Foreign Application Priority Data
Sep. 30, 2010 (JP) 2010-222190

(51) Int. Cl. H01R 4/26; H01R 43/20; B23P 11/00

(52) U.S. Cl. 439/387; 29/426.5; 29/426.4

(57) ABSTRACT

A method of detachment of a connector which is provided with a housing having connector pins to be inserted into a board and with a first member which is arranged between the housing and the board and through which the connector pins are inserted, the method including a process of pulling out the connector pins from the board. This process utilizes the lever principle, which uses the first member as a fulcrum and which uses any point on the housing as a point of action, so as to pull out the connector pins from the board.

### CROSS-REFERENCE TO RELATED APPLICATION

This application is based upon and claims the benefit of priority of the prior Japanese Patent Application No. 2010-222190, filed on Sep. 10, 2010, the entire contents of which are incorporated herein by reference.

### FIELD

The present invention relates to a method of detachment of a connector, a connector detachment tool, and a connector.

### BACKGROUND

A computer circuit board has memory modules and other devices mounted to it through connectors. Since the circuit board has expensive controlling circuit components etc. mounted on it, if a connector turns out to be defective, it is preferable to remove just the connector from the board. In recent years, sometimes control circuit components, memory modules, and other devices have been mounted on the front surfaces of thick boards and SMT devices have been mounted on the back surfaces. In such cases, the connector terminals do not pass through the boards, so detachment of the connectors becomes more difficult. Therefore, Japanese Laid-Open Patent Publication No. 8-264976 discloses the technique of utilizing the lever principle so as to pull out electronic circuit packages.

However, if using the lever principle to detach a connector, the board is liable to be damaged. Further, when other components etc. are arranged near the connector from the viewpoint of saving space, the other components are liable to end up being damaged when detaching the connector.

### SUMMARY

Accordingly, it is an object of this disclosure to provide a method of detachment of a connector, a connector detachment tool, and a connector, which enable the effects on the board and other components etc. to be suppressed when detaching a connector.

According to a first aspect of the disclosure, there is provided a method of detachment of a connector which is provided with a housing which has connector pins to be inserted into a board and with a first member which is located between the housing and the board and through which the connector pins are inserted, the method including a process of utilizing a lever principle, which uses the first member as a fulcrum and which uses any point on the housing as a point of action, so as to pull out the connector pins from the board.

According to a second aspect of the disclosure, there is provided a detachment tool of a connector which is provided with a housing which has connector pins to be inserted into a board and a first member which is located between the housing and the board and through which the connector pins are inserted, the housing provided with a second member which covers the first member, the detachment tool of a connector provided with a cutting part for cutting the second member and an action member which uses a contact point between the cutting part and the first member as a fulcrum and acts on the housing in a direction which pulls out the connector pins from the board.

According to a third aspect of the disclosure, there is provided a connector which is provided with a housing which has connector pins to be inserted into a board and a first member which is located between the housing and the board and through which the connector pins are inserted, wherein the housing has a second member which covers the first member, and the second member has a partial cut in a longitudinal direction of the housing so that part of the first member is exposed.

### BRIEF DESCRIPTION OF DRAWINGS

These and other objects and features of the present invention will become clearer from the following description of the preferred embodiments given with reference to the attached drawings, wherein:

FIG. 1A is a front view of a connector, FIG. 1B is a top view of the connector, FIG. 1C is an enlarged view of a later explained skeleton, and FIG. 1D is an enlarged view of a later explained connector pin;

FIG. 2 is a perspective view for explaining a state in which a connector is connected to a board;

FIGS. 3A to 3D are views for explaining a method of detachment of a connector according to a first embodiment;

FIGS. 4A to 4E are views for explaining a first step in a method of detachment of a connector according to a second embodiment;

FIGS. 5A to 5F are views for explaining a second step in a method of detachment of a connector according to a second embodiment;

FIGS. 6A to 6C are views for explaining a third step in a method of detachment of a connector according to a second embodiment;

FIGS. 7A to 7D are views for explaining a part of a method of detachment of a connector according to a third embodiment;

FIGS. 8A and 8B are views for explaining a detachment tool; and

FIGS. 9A to 9C are views for explaining a connector according to a fifth embodiment.

### DESCRIPTION OF EMBODIMENTS

Additional objects and advantages of the disclosure will be set forth in part in the description which follows, and in part will be obvious from the description, or may be learned by practice of the invention. The object and advantages of the invention will be realized and attained by means of the elements and combinations particularly pointed out in the appended claims. It is to be understood that both the foregoing general description and the following detailed description are exemplary and explanatory only and are not restrictive of the disclosure, as claimed.

The method of detachment of a connector, the connector detachment tool, and the connector of the disclosure of the specification enable a connector to be detached while minimizing any effects on the board and other components etc.

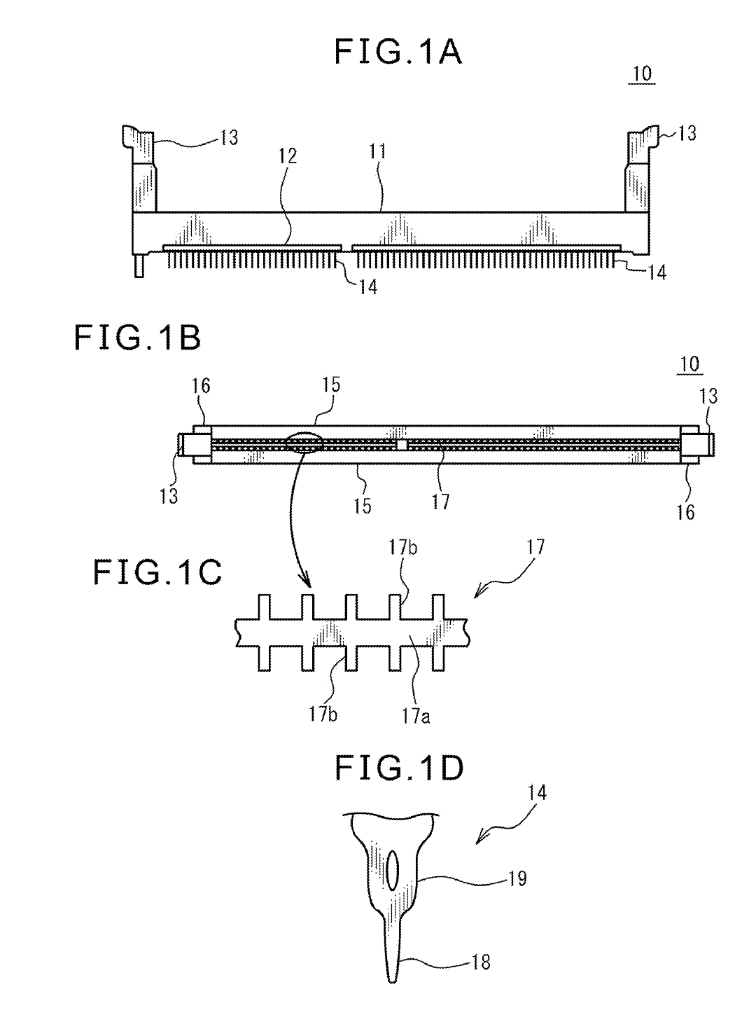

First, a connector 10 which is used in the following embodiments will be explained. The connector 10, as one example, is a press-fit (PF) type dual in-line memory module (DIMM) connector. FIG. 1A is a front view of the connector 10, FIG. 1B is a top view of the connector 10, FIG. 1C is an enlarged view of a later explained skeleton 17, and FIG. 1D is an enlarged view of a later explained connector pin 14.

Referring to FIG. 1A and FIG. 1B, the connector 10 is provided with a molded part 11, a base plate 12, latches 13, a plurality of connector pins 14, etc. The molded part 11 functions as the housing of the connector 10 and is provided with two long side wall surface parts 15, two short side wall surface parts 16, and a skeleton 17. The molded part 11 is, for example, comprised of a plastic etc. The two long side wall surface parts 15 are side wall surface parts which extend in a longitudinal direction of the connector 10 and are arranged in parallel facing each other across a predetermined distance. Further, each of the long side wall surface parts 15 is provided with one or more rows of connector pins 14. The connector pins 14 form rows in the longitudinal direction of the connector 10. Each connector pin 14 extends from a long side wall surface part 15 to the board direction. The “board direction” is the direction toward the board to which the connector 10 is connected.

The two short side wall surface parts 16 are surface parts which extend in a width (short side) direction of the connector 10. The two long side wall surface parts 15 are connected at their respective ends by the respective short side wall surface parts 16. Due to this, the two long side wall surface parts 15 and the two short side wall surface parts 16 form the side walls of the molded part 11. Further, the two long side wall surface parts 15 are connected by the skeleton 17. Referring to FIG. 1C, the skeleton 17 is comprised of a spine 17a which extends in the longitudinal direction of the long side wall surface parts 15 and a plurality of ribs 17b which extend from the spine 17a toward the long side wall surface parts 15. The ends of the ribs 17b are connected to the long side wall surface parts 15, whereby the two long side wall surface parts 15 are connected by the skeleton 17. The skeleton 17 is arranged between the two short side wall surface parts 16 at the board side.

The base plate 12 is arranged under the bottom of the skeleton 17 (between ends of the two short side wall surface parts 16 at the board side). The base plate 12 is formed with through holes for passage of the connector pins 15. When the connector 10 is connected to the board, the connector pins 14 are inserted via the through holes of the base plate 12 to the terminal holes of the board. The base plate 12 is a separate member from the long side wall surface parts 15 and can be separated from the long side wall surface parts 15 without cutting any specific members. Further, the base plate 12 may be bonded to the long side wall surface parts 15, but can be separated from the long side wall surface parts 15 by applying a predetermined force. The base plate 12 is, for example, made of a plastic etc. The latches 13 are members which fasten the memory module to the connector 10.

Referring to FIG. 1D, each connector pin 14 is provided with a leg part 18 and a spring part 19. The leg part 18 is provided at the front end of the connector pin 14 and is inserted into a terminal hole of the board. The spring part 19 is formed larger in diameter or thicker than the leg part 18. Due to this, when the spring part 19 is inserted into the terminal hole of the board, the connector pin 14 is tightly fastened to the board.

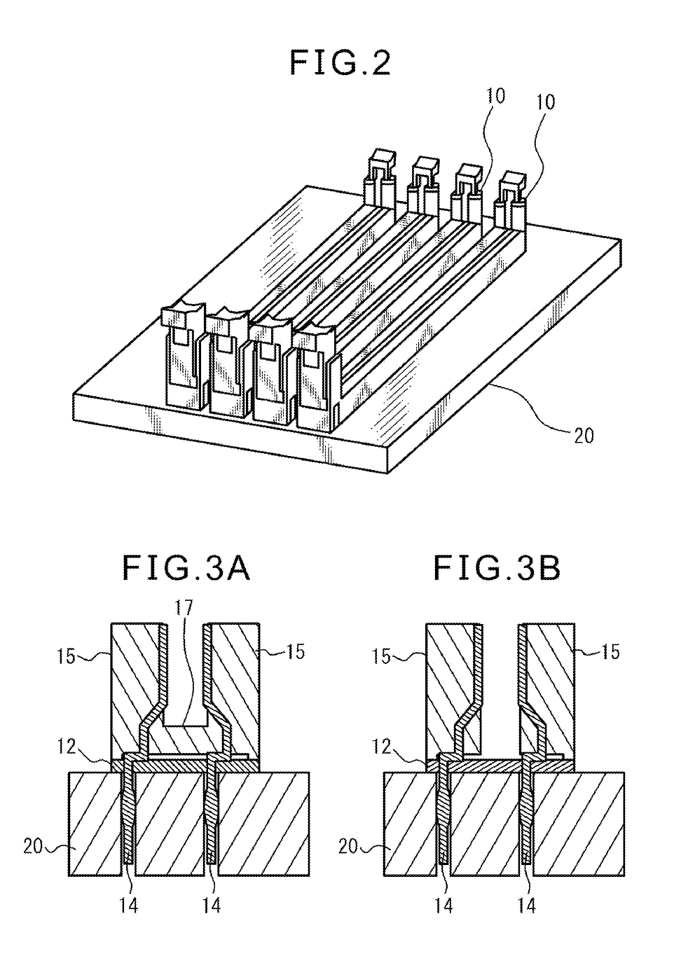

FIG. 2 is a perspective view for explaining the state where a connector 10 is connected to a board 20. Referring to FIG. 2, a plurality of connectors 10 may be arranged in parallel adjoining each other. The connector pins 14 are inserted into the terminal holes of the board 20 whereby the connectors 10 are fastened to the board 20.

As one example, each connector 10 is provided with 240 connector pins 14. Further, the holding force for the connector pins 14 at the board 20 is, for example, 2 kg/pin. In this case, to detach a connector 10 from the board 20, a force of about 500 kg is required. From the viewpoint of saving space, the connectors 10 are often arranged with high density. Therefore, if applying a large force to a specific connector, the other connectors, the other components, etc. may also be damaged. In particular, when the board 20 is formed thicker than the lengths by which the connector pins 14 extend from the base plate 12, the connector pins 14 will end up not passing through the board 20 to its back surface. Therefore, in this case, it is not possible to push the connector pins 14 upward from the back surface side of the board, so detachment of a connector 10 becomes more difficult.

In the following embodiments, it is possible to detach a specific connector from a board while minimizing the effects on the other connectors and other components. Embodiments of the method of detachment of a connector, connector detachment tool, and connector will be explained.

### (1) First Embodiment

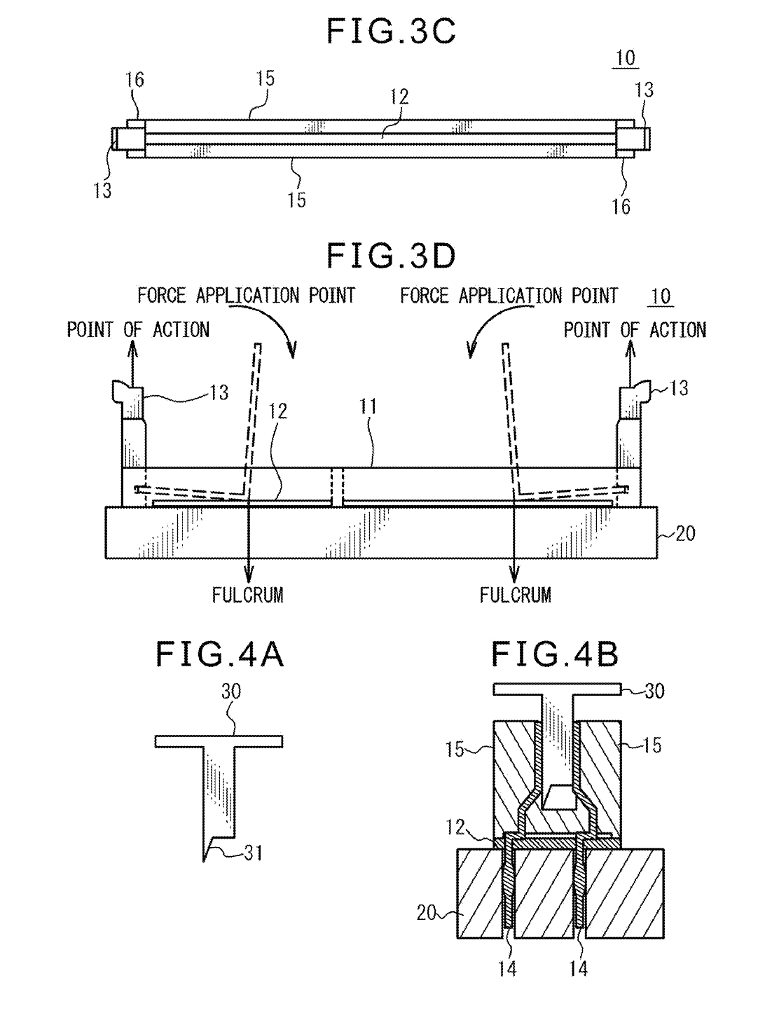

FIG. 3A to FIG. 3D are views for explaining the method of detachment of the connector 10. FIG. 3A and FIG. 3B are schematic cross-sectional views of the connector 10 and board 20. FIG. 3C is a top view of the connector 10. FIG. 3D is a view schematically illustrating the forces applied to the connector 10.

First, referring to FIG. 3A, the connector 10 is fastened to the board 20 by insertion of the connector pins 14 to the terminal holes of the board 20. At the step of FIG. 3A, the skeleton 17 connects the long side wall surface parts 15. Due to this, the base plate 12 is not exposed. Next, referring to FIG. 3B, the skeleton 17 is removed. Specifically, the ribs 17b of the skeleton 17 are cut so as to remove the skeleton 17. By this, referring to FIG. 3C, the base plate 12 is exposed at its top surface side (side opposite to board 20). Here, the “exposure” of the base plate 12 refers to the state where the skeleton 17 on the base plate 12 is removed.

Next, referring to FIG. 3D, the lever principle is utilized to apply forces in a direction detaching the connector 10 from the board 20 using the base plate 12 as fulcrums. As one example, force application points are set so that points of action are positioned at the short side wall surface parts 16 and at the sides opposite to the board 20. In this case, rather than using the board 20 for the fulcrums, the base plate 12, which is provided at the connector 10, is used for the fulcrums, so it is possible to utilize the lever principle using the long distance along the long side wall surface parts 15. By this, it is possible to reduce the forces required at the force application points compared with the forces applied to the points of action. As a result, detachment of the connector 10 becomes easy, so damage to the adjoining other connectors, other components, etc. is suppressed.

### (2) Second Embodiment

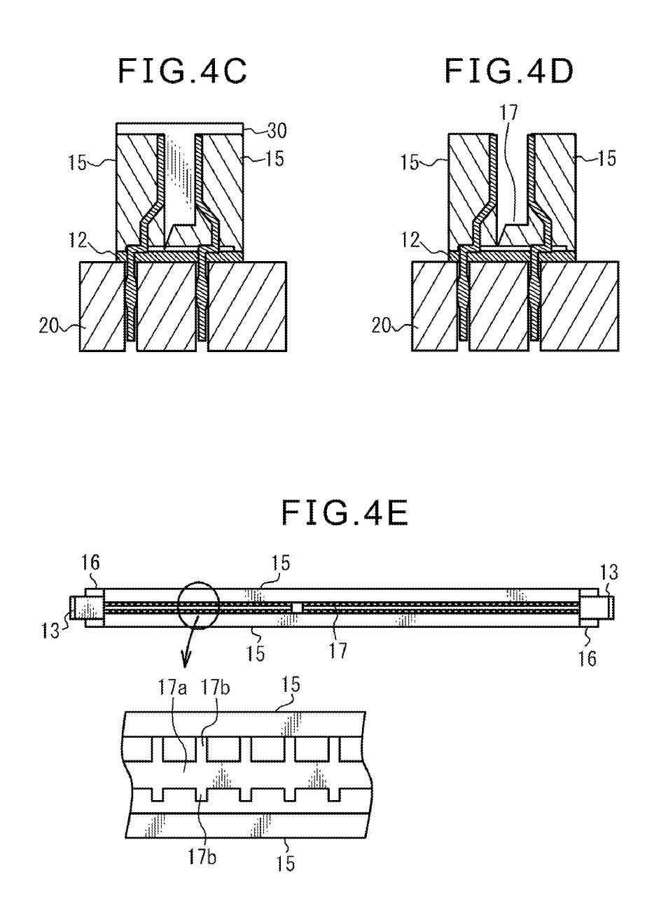

Next, a method of detachment of the connector 10 according to a second embodiment will be explained. FIG. 4A to FIG. 4E are views for explaining a first step of the method of detachment of the connector 10 according to the second embodiment. FIG. 4A is a view for explaining a cutting tool 30 used for cutting the skeleton 17. FIG. 4B to FIG. 4D are schematic cross-sectional views of the connector 10 and the board 20. In FIG. 4B to FIG. 4D, the connector pins 14 of the connector 10 are inserted into the terminal holes of the board 20. FIG. 4E is a partially enlarged top view of the connector 10.

First, referring to FIG. 4A, the cutting tool 30 is prepared. The cutting tool 30 has a thickness of an extent for insertion between the two long side wall surface parts 15. The cutting tool 30 has a blade 31 at its front end of the board 20 side. The blade 31 is provided at a position which can cut the ribs 17b on one side of the skeleton 17. As one example, the blade 31 is provided along one of the surfaces of the cutting tool 30 which faces the long side wall surface parts 15.

Next, referring to FIG. 4B, the cutting tool 30 is inserted between two long side wall surface parts 15 and the blade 31 is pushed against the ribs 17b at one side of the skeleton 17. By this, referring to FIG. 4C, the ribs 17b at a single side of the skeleton 17 are cut. Referring to FIG. 4E, the ribs 17b at one side of the skeleton 17 are cut, leaving the ribs 17b at the other side are connected to the long side wall surface parts 15. Next, referring to FIG. 4D, the cutting tool 30 is detached from the connector 10. After the above process, the first step is ended.

Note that the process from FIG. 4B to FIG. 4D may also be performed when connecting the connector 10 to the board 20. Specifically, the cutting tool 30 is pushed against the skeleton 17, and the connector pins 14 are inserted into the terminal holes of the board 20. In this case, the connector 10 is connected to the board 20, and the ribs 17 at a single side of the skeleton 17 are cut. Even if the ribs 17b at single side are cut, the connector 10 is still connected to the board 20, so it is possible to mount a memory etc. on the connector 10. In this case, when detaching the connector 10, it is possible to bypass the process of FIG. 4B to FIG. 4D, so the work is simplified.

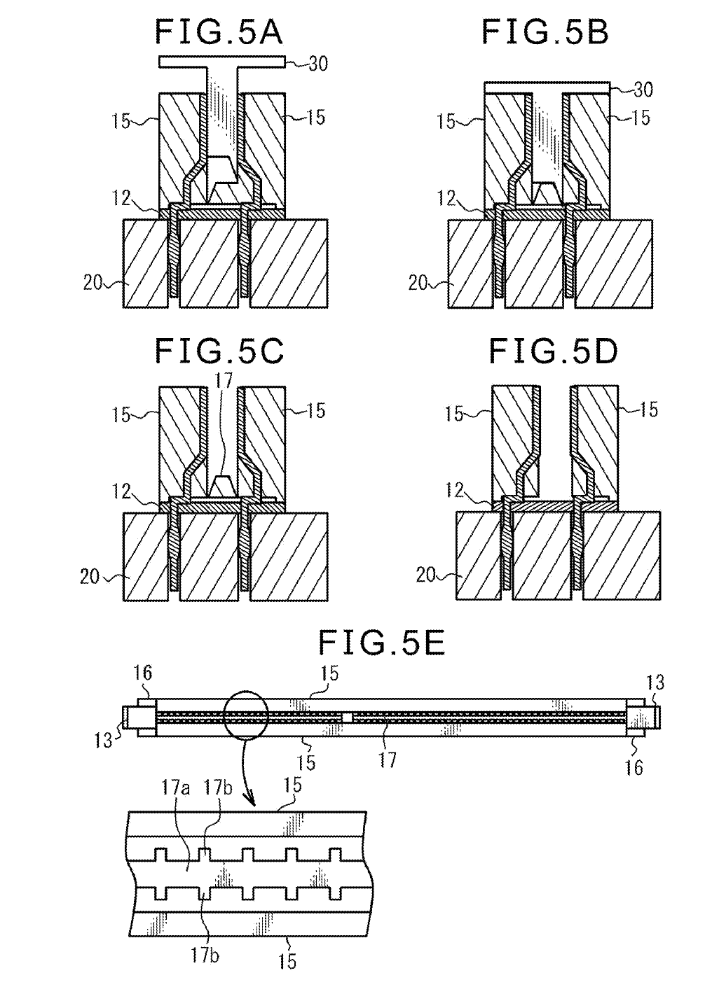

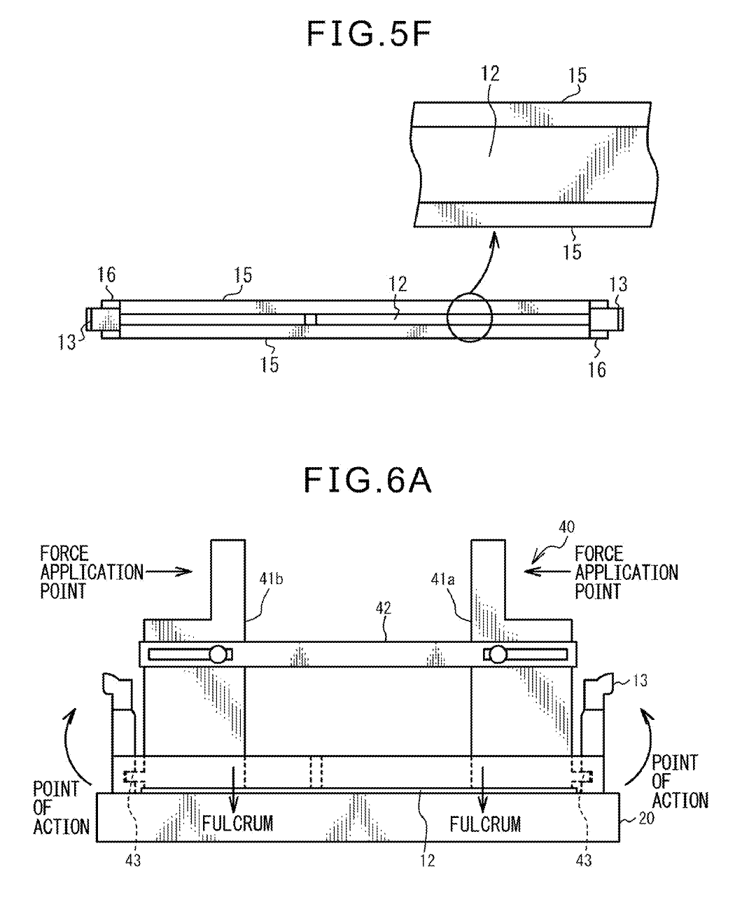

FIG. 5A to FIG. 5F are views for explaining a second step in the method of detachment of a connector 10 according to the second embodiment. FIG. 5A to FIG. 5D are schematic cross-sectional views of the connector 10 and board 20. In FIG. 5A to FIG. 5D, the connector pins 14 of the connector 10 are inserted into the terminal holes of the board 20. FIG. 5E and FIG. 5F are partially enlarged top views of the connector 10.

Next, referring to FIG. 5A, the cutting tool 30 is inserted between the two long side wall surface parts 15 so that the blade 31 of the cutting tool 30 is arranged along the skeleton 17 at the side (other side) of the ribs 17b which are not cut. Next, referring to FIG. 5B, the blade 31 is pushed against the ribs 17b of that other side of the skeleton 17. Due to this, the ribs 17b at that other side of the skeleton 17 are cut. By this, the skeleton 17 is separated from the connector 10. Next, referring to FIG. 5C, the cutting tool 30a is removed from the connector 10. FIG. 5E illustrates the state of the ribs 17b at the two sides of the skeleton 17 cut. Next, referring to FIG. 5D, the skeleton 17 is removed. FIG. 5F illustrates the state after the skeleton 1 has been removed. Referring to FIG. 5F, when the skeleton 17 is removed, the base plate 12 is exposed.

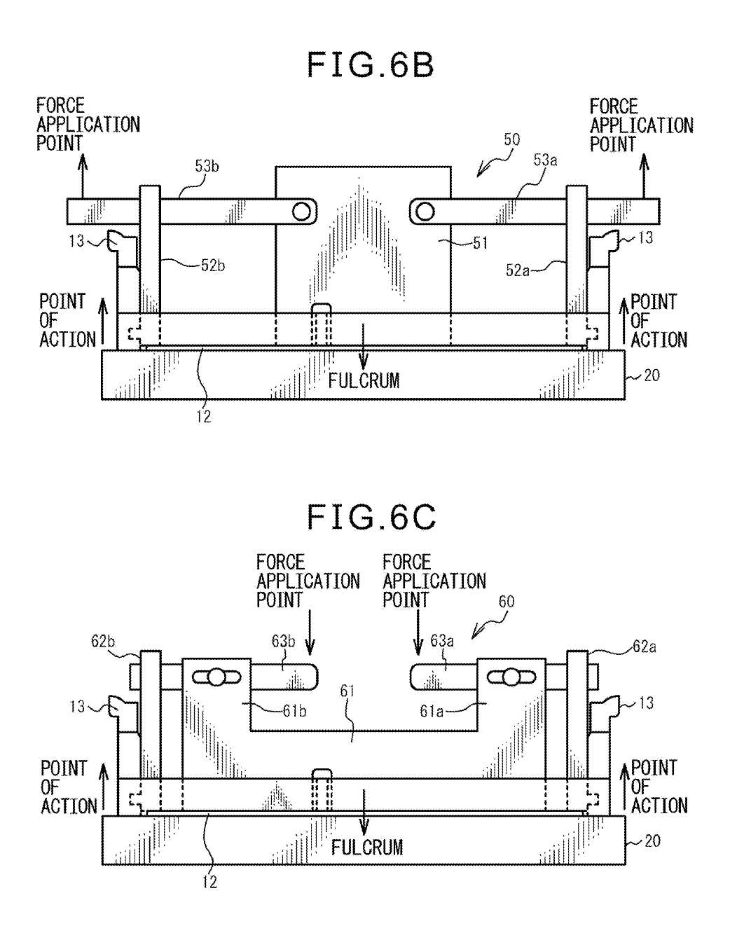

FIG. 6A to FIG. 6C are views for explaining a third step in the method of detachment of the connector 10 according to the second embodiment. Referring to FIG. 6A, a detachment tool 40 for pulling out connector pins 14 from the board 20 is prepared. The detachment tool 40 is a tool for realizing the lever principle which was explained in FIG. 3D.

The detachment tool 40 includes a pair of action members 41a and 41b and a support member 42. The support member 42 is a member which extends along the long side wall surface parts 15. The support member 42 rotatably supports the action member 41a at one end and rotatably supports the action member 41b at the other end. To enable adjustment of the distance between the action member 41a and the action member 41b and to enable the fulcrums of the support member 42 to be slid, it is also possible that the support member 42 be formed with slits extending in the longitudinal direction of the connector 10. The action members 41a and 41b can pivot about the points supported by the support member 42 with the longitudinal directions as the radial directions, of the action members 41a and 41b. The planes drawn by rotation of the action members 41a and 41b match the surfaces of the long side wall surface parts 15 facing these members 41a and 41b.

The action members 41a and 41b are provided with projections 43 which engage with recesses in the short side wall surface parts 16, at the outsides in the longitudinal direction of the connector 10 and at the board 20 side. To make the action members 41a and 41b rotate so that forces are applied, via the projections 43, to the recesses in the short side wall surface parts 16 in the opposite direction from the board 20, it is necessary to apply forces to the ends of the action members 41a and 41b at the opposite sides to the board 20. In this case, the ends of the action members 41a and 41b, at the opposite sides from the board 20, function as the force application points. The connector 10 is fastened to the board 20, so rotation of the action members 41a and 41b is obstructed by the recesses in the short side wall surface parts 16. In this case, the ends of the action members 41a and 41b, at the board 20 side, function as the fulcrums. Further, the projections 43 function as the points of action.

In this case, rather than using the board 20 for the fulcrums, the base plate 12, which is provided at the connector 10, is used for the fulcrums, so it is possible to minimize damage to the board 20. Further, the points of action are set at the short side wall surface parts 16, so it is possible to apply the lever principle utilizing the longitudinal direction of the long side wall surface parts 15. Due to this, it is possible to reduce the forces required at the force application points compared with the forces required at the points of action. As a result, detachment of the connector 10 becomes easy, so damage to the adjoining other connectors, other components, etc. is suppressed.

FIG. 6B is a view for explaining another detachment tool 50. Referring to FIG. 6B, the detachment tool 50 includes a fulcrum member 51, two action point members 52a and 52b, two force application members 53a and 53b, etc. The fulcrum member 51 is arranged at the center between the two long side wall surface parts 15. The force application member 53a is a rod-shaped member which extends from the fulcrum member 51 to one side in the longitudinal direction of the long side wall surface parts 15. The force application member 53b is a rod-shaped member which extends from the fulcrum member 51 to the other side in the longitudinal direction of the long side wall surface parts 15. The ends of the force application members 53a and 53b at the fulcrum member 51 sides are rotatably supported at the fulcrum member 51. The force application members 53a and 53b can rotate about the points which are supported by the fulcrum member 51 with the longitudinal direction, as the radial directions, of the force application members 53a and 53b. The planes drawn by rotation of the force application members 53a and 53b match the surfaces of the long side wall surface parts 15 facing these members 53a and 53b. The action point member 52a has one end connected in the middle of the force application member 53a and has a projection at the other end engaged with a recess in one short side wall surface part 16. The action point member 52b has one end connected in the middle of the force application member 53b and has a projection at the other end engaged with a recess of the other short side wall surface part 16.

According to the above configuration, by applying forces to the ends of the force application members 53a and 53b at the opposite sides to the fulcrum member 51 and at the opposite side from the board 20, tensile forces act on the action point members 52a and 52b in a direction at the opposite side from the board 20. However, the connector 10 is held at the board 20, so the forces, which are applied to the force application members 53, act to the base plate 12 through the fulcrum member 51. In this case, the ends of the force application members 53a and 53b, at the opposite sides from the fulcrum member 51, function as force application members, the portion where the fulcrum member 51 contacts the base plate 12 functions as fulcrum, and the recesses in the short side wall surface parts 16, with which the projections of the action point members 52a and 52b engage, function as points of action.

In this case, rather than using the board 20 for the fulcrum, the base plate 12, which is provided at the connector 10, is used for the fulcrum, so it is possible to minimize damage to the board 20. Further, the points of action are set at the short side wall surface parts 16, so it is possible to apply the lever principle utilizing the longitudinal direction of the long side wall surface parts 15. Due to this, it is possible to reduce the force required at the force application point compared with the forces required at the points of action. As a result, detachment of the connector 10 becomes easy, so damage to the adjoining other connectors, other components, etc. is suppressed.

FIG. 6C is a view for explaining another detachment tool 60. Referring to FIG. 6C, the detachment tool 60 includes a fulcrum member 61, action point members 62a and 62b, force application members 63a and 63b, etc. The fulcrum member 61 is arranged at the center between the two long side wall surface parts 15. Further, the fulcrum member 61 is provided with a support member 61a which extends at one end in the direction of the long side wall surface parts 15 and at the opposite side from the board 20 and is provided with a support member 61b which extends at the other end in the direction of the long side wall surface parts 15 and at the opposite side from the board 20.

The force application members 63a and 63b are rod-shaped members which extend in the longitudinal direction of the long side wall surface parts 15. The force application member 63a is supported at its approximate center so that it can rotate about the support member 61a. The force application member 63b is supported at its approximate center so that it can rotate about the support member 61b. The force application members 63a and 63b can rotate about the supported points with the longitudinal directions, as the radial directions, of the force application members 63a and 63b. The planes which are drawn by rotation of the force application members 63a and 63b match the surfaces of the long side wall surface parts 15 facing these members 63a and 63b. The action point member 62a is connected, at one end, to the force application member 63a and has a projection at the other end engaged with the recess in the short side wall surface part 16. The action point member 62b is connected, at one end, to the force application member 63b and has a projection at the other end engaged with the recess in the short side wall surface part 16. The locations at which the action point members 62a and 62b are connected to the force application members 63a and 63b are at the outer sides from the supports members 61a and 61b in the longitudinal direction of the connector 10.

According to the above configuration, by applying force in the direction to the board 20 side to the inner ends of the force application members 63a and 63b, tensile forces act on the action point members 62a and 62b in the opposite direction from the board 20. However, the connector 10 is held at the board 20, so the forces acting on the force application members 63a and 63b are applied to the base plate 12 through the fulcrum member 61. In this case, the inside ends of the force application members 63a and 63b function as the force application members, the fulcrum member 61 functions as the fulcrum, and the recesses in the short side wall surface parts 16, with which the projections of the action point members 62a and 62b engage, function as the points of action.

In this case, rather than using the board 20 for the fulcrum, the base plate 12, which is provided at the connector 10, is used for the fulcrum, so it is possible to minimize damage to the board 20. Further, the points of action are set at the short side wall surface parts 16, so it is possible to apply the lever principle utilizing the longitudinal direction of the long side wall surface parts 15. Due to this, it is possible to reduce the force required at the force application point compared with the force required at the point of action. As a result, detachment of the connector 10 becomes easy, so damage to the adjoining other connectors, other components, etc. is suppressed.

Note that in the example of FIG. 6A to FIG. 6C, the recesses which are provided in the short side wall surface parts 16 function as points of action, but the disclosure is not limited to this. For example, if projections are provided at the short side wall surface parts 16, the projections may also be used as the points of action.

### (3) Third Embodiment

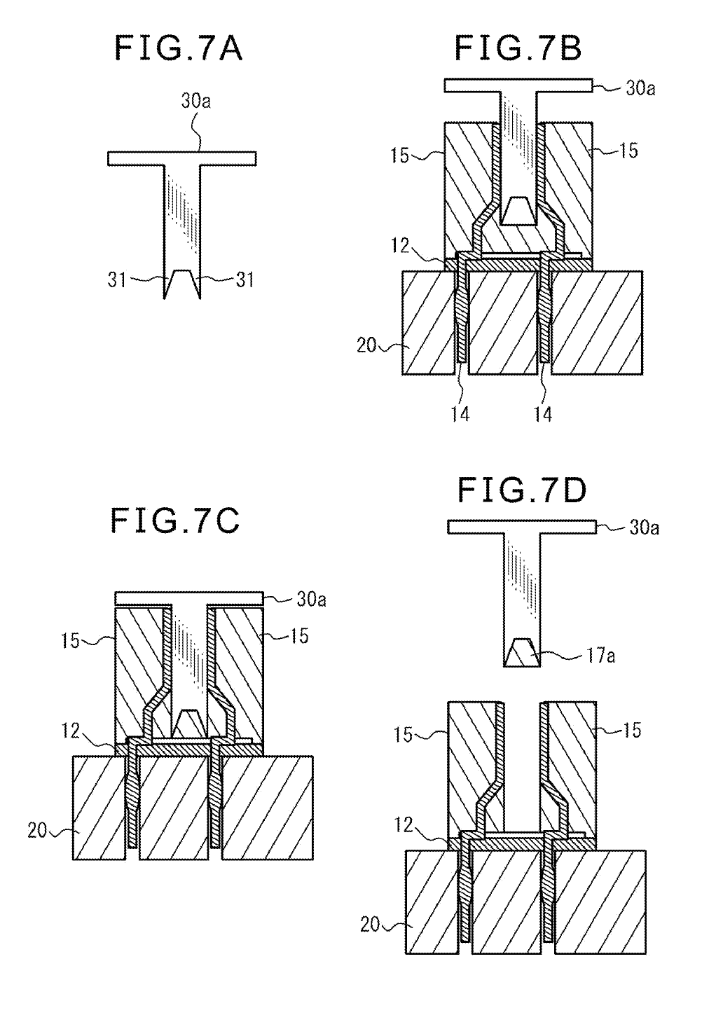

Next, a method of detachment of the connector 10 according to the third embodiment will be explained. FIG. 7A to FIG. 7D are views for explaining part of the method of detachment of the connector 10 according to the third embodiment. FIG. 7A is a view for explaining a cutting tool 30a which is used for cutting the skeleton 17. FIG. 7B to FIG. 7D illustrate schematic cross-sections of the connector 10 and the board 20. In FIG. 7B to FIG. 7D, the connector pins 14 of the connector 10 are inserted into the terminal holes of the board 20.

First, referring to FIG. 7A, a cutting tool 30a is prepared. The cutting tool 30a has a thickness of an extent for insertion between the two long side wall surface parts 15. The cutting tool 30a has a set of blades 31 at its front end and at the board 20 side. The set of blades 31 are arranged facing each other across a predetermined distance. One blade 31 is provided at a position able to cut the ribs 17b at one side of the skeleton 17. The other blade 31 is provided at a position able to cut the ribs 17b at the other side of the skeleton 17. As one example, the blades 31 are provided along the surfaces of the cutting tool 30a facing the surfaces of the long side wall surface parts 15.

Next, referring to FIG. 7B, the cutting tool 30a is inserted between the two long side wall surface parts 15, and the blades 31 are pushed against the ribs 17b of the skeleton 17. Due to this, referring to FIG. 7C, the ribs 17b at the two sides of the skeleton 17 are cut. Next, referring to FIG. 7D, the cutting tool 30a is removed from the connector 10. The skeleton 17 is held by the two blades 31, so when the cutting tool 30a is detached from the connector 10, the skeleton 17 is also removed together with it. By this, the base plate 12 is exposed. Next, by detaching the connector 10 as in FIG. 6A to FIG. 6C, the connector 10 finishes being detached. In the present embodiment, the skeleton 17 is also removed when detaching the cutting tool 30a, so the work is simplified.

### (4) Fourth Embodiment

Next, a detachment tool 70 of the connector 10 will be explained. The detachment tool 70 is a tool which enables the skeleton 17 to be cut and the connector pins 14 to be pulled out by the same process. The detachment tool 70 is a tool of a modification of the detachment tool 40 of FIG. 6A, as one example.

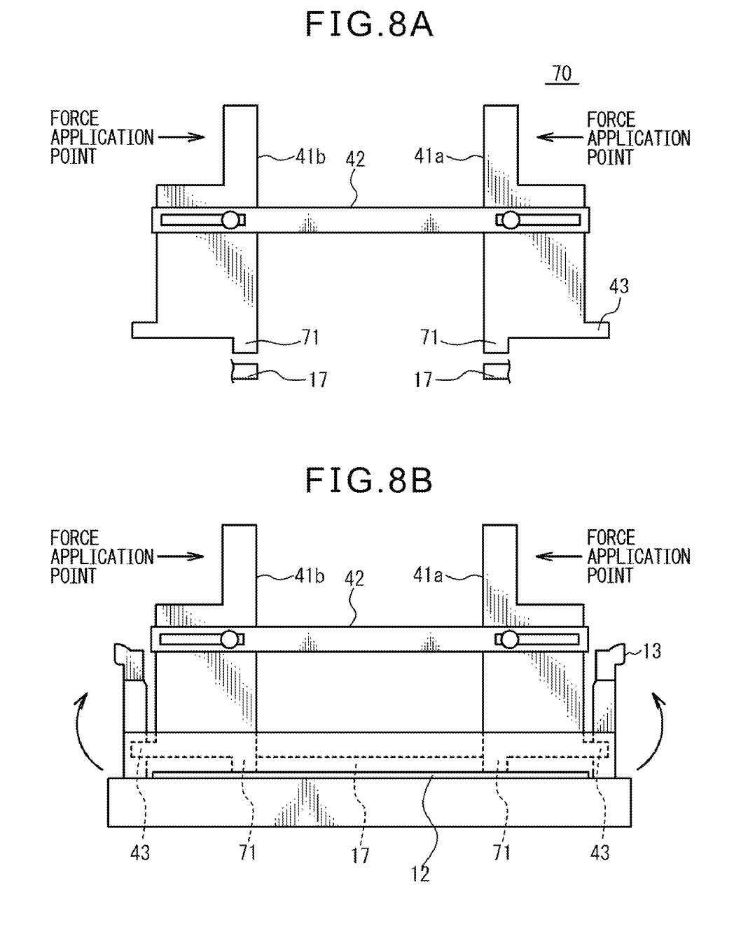

Referring to FIG. 8A, the detachment tool 70 is configured as the detachment tool 70 which is further provided with a pair of blades 71 for cutting the ribs 17b at the two sides of the skeleton 17. The pair of blades 71 are provided at the fulcrums of FIG. 6A. One blade 71 is, for example, provided at a position able to cut the ribs 17b at one side of the skeleton 17. The other blade 71 is provided at a position able to cut the ribs 17b at the other side of the skeleton 17. As one example, the blades 71 are provided along the surfaces of the detachment tool 70 facing the long side wall surface parts 15.

Referring to FIG. 8B, the detachment tool 70 is inserted between the long side wall surface parts 15.

Further, the action members 41a and 41b are turned so that force acts at the opposite side from the board 20, via the projections 43, to the recesses in the short side wall surface parts 16. In this case, the projections 43 function as fulcrums and the blades 71 act as points of action. Due to this, the blades 71 cut the skeleton 17. If further trying to make the action members 41a and 41b rotate, the blades 71 contact the base plate 12. In this case, the points where the blades 71 contact the base plate 12 function as fulcrums. Further, the projections 43 function as points of action.

In this case, rather than using the board 20 for the fulcrums, the base plate 12, which is provided at the connector 10, is used for the fulcrums, so it is possible to minimize damage to the board 20. Further, the points of action are set at the short side wall surface parts 16, so it is possible to apply the lever principle utilizing the longitudinal direction of the long side wall surface parts 15. Due to this, it is possible to reduce the forces required at the force application points compared with the forces required at the points of action. As a result, detachment of the connector 10 becomes easy, so damage to the adjoining other connectors, other components, etc. is suppressed.

### (5) Fifth Embodiment

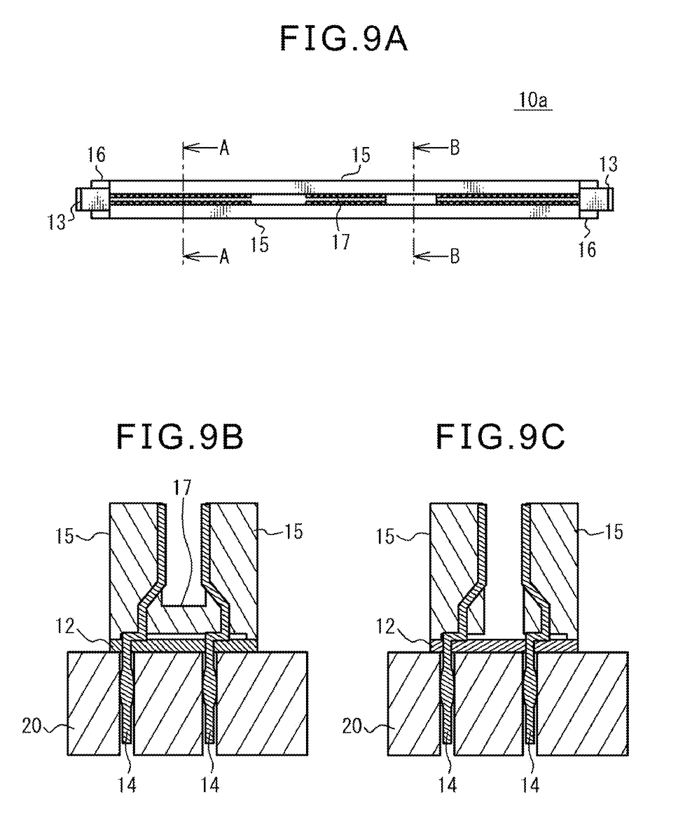

Next, a connector 10a according to a fifth embodiment will be explained. FIG. 9A is a top view of the connector 10a. FIG. 9B is a cross-sectional view taken along the line A-A of FIG. 9A. FIG. 9C is a cross-sectional view taken along the line B-B of FIG. 9A. Referring to FIG. 9A, in the connector 10a, the skeleton 17 has partial cuts in the longitudinal direction of the long side wall surface parts 15 so that part of the base plate 12 is exposed. In the example of FIG. 9A, the skeleton 17 has two partial cuts.

According to this configuration, the base plate 12 is exposed even without later cutting the skeleton 17. Due to this, by using the exposed base plate 12 for the fulcrums and using the short side wall surface parts 16 for the points of action, it is possible to detach the connector 10a while minimizing damage to the board 20.

Note that in the above embodiments, the base plate 12 corresponds to the first member which is arranged between the housing and board and through which the connector pins pass, while the skeleton 17 corresponds to the second member which covers the first member and corresponds to the connection part which connects the pair of long side wall surface parts.

All examples and conditional language recited above were intended for pedagogical purposes to aid the reader in understanding the principles of the disclosure and the concepts contributed by the inventor to furthering the art and are to be construed as being without limitation to such specifically recited examples and conditions. Nor does the organization of such examples in the specification relate to a showing of the superiority and inferiority of the invention. Although the embodiments of the disclosure have been described in detail, it should be understood that the various changes, substitutions, and alterations could be made hereto without departing from the spirit and scope of the disclosure.

1. A method of detachment of a connector which is provided with a housing having connector pins to be inserted into a board, the method comprising:
arranging a first member between the housing and the board and through which the connector pins are inserted,
utilizing a lever principle, which uses the first member as a fulcrum by using any point on the housing as a point of action; and
pulling out the connector pins from the board by the lever principle.

2. The method of detachment of a connector according to claim 1, wherein the housing comprising a second member which covers the first member, and
the method further comprises removing the second member.

3. The method of detachment of a connector according to claim 1, wherein the board is formed thicker than a length by which the connector pins extend from the first member.

4. The method of detachment of a connector according to claim 1, wherein
the housing comprising a pair of long side wall surface parts which are connected facing each other by a connecting part and a pair of width side wall surface parts connecting two adjoining ends of the long side wall surface parts, and
the second member is the connecting part.

5. The method of detachment of a connector according to claim 4, wherein in the pulling out the connector pins from the board, the width side wall surface parts are made points of action.

6. The method of detachment of a connector according to claim 4, wherein
the connecting part includes a spine which extends in a longitudinal direction of the long side wall surface parts and ribs which extend from the spine to the long side wall surface parts, and
the ribs are cut in the removing the second member.

7. The method of detachment of a connector according to claim 6, wherein in the removing the second member, a tool is provided with two blades to cut the ribs extending from the two sides of the spine, at one time, by the two blades.

8. The method of detachment of a connector according to claim 6, wherein further including
cutting the ribs extending from a single side of the spine by a single blade of a tool, while inserting the connector pins into the board, and
in the removing the second member, the other ribs extending from the spine are cut.

9. The method of detachment of a connector according to claim 4, wherein further forming inside walls of the short side wall surface parts with projections or recesses for use as the points of action.

10. A detachment tool of a connector which is provided with a housing having connector pins to be inserted into a board and with a first member which is arranged between the housing and the board and through which the connector pins are inserted, the housing provided with a second member which covers the first member, the detachment tool of the connector comprising:
a cutting part for cutting the second member and
an action member which uses a contact point between the cutting part and the first member as a fulcrum and acts on the housing a force in a direction for pulling out the connector pins from the board.

11. A connector comprising,
a housing which is provided with connector pins to be inserted into a board and
a first member which is arranged between the housing and the board and through which the connector pins are inserted, wherein
the housing comprising a second member which covers the first member, and
the second member has a partial cut in a longitudinal direction of the housing to expose part of the first member.
